(19) United States
(12) Patent Application Publication
(10) Pub. No.: US 2025/0200358 A1
(43) Pub. Date: Jun. 19, 2025

(54) HYBRID GENERATIVE ARTIFICIAL INTELLIGENCE MODELS

(71) Applicant: QUALCOMM Incorporated, San Diego, CA (US)

(72) Inventors: Mingu LEE, San Diego, CA (US); Christopher LOTT, San Diego, CA (US); Joseph Binamira SORIAGA, San Diego, CA (US); Jilei HOU, San Diego, CA (US); Muralidhar Reddy AKULA, San Diego, CA (US); Jeffrey Baginsky GEHLHAAR, San Diego, CA (US)

(21) Appl. No.: 18/543,609

(22) Filed: Dec. 18, 2023

Related U.S. Application Data
(60) Provisional application No. 63/462,198, filed on Apr. 26, 2023.

(51) Int. Cl. G06N 3/08; G06N 5/022

(52) U.S. Cl. CPC G06N 3/08; G06N 5/022

(57) ABSTRACT

Certain aspects of the present disclosure provide techniques and apparatus for generating a response to an input query using a generative artificial intelligence model. An example method generally includes receiving an input for processing. A prompt representing the received input is generated based on the received input, contextual information associated with the received prompt, and a prompt-generating artificial intelligence model. The generated prompt is output to a generative artificial intelligence model for processing. A response to the generated prompt is received from the generative artificial intelligence model and output as a response to the received input.

### CROSS-REFERENCE TO RELATED APPLICATIONS

This application claims benefit of and priority to U.S. Provisional Patent Application Ser. No. 63/462,198, entitled “Hybrid Generative Artificial Intelligence Models,” filed Apr. 26, 2023, and assigned to the assignee hereof, the entire contents of which are hereby incorporated by reference.

### INTRODUCTION

Aspects of the present disclosure relate to generative artificial intelligence models, and more specifically to hybrid generative artificial intelligence models executing on edge devices and in a cloud environment.

Generative artificial intelligence models can be used in various environments in order to generate a response to an input query. For example, generative artificial intelligence models can be used in chatbot applications in which large language models are used to generate an answer, or at least a response, to an input query. Other examples in which generative artificial intelligence models can be used include stable diffusion, in which a model generates an image from an input text description of the content of the desired image, and decision transformers, in which future actions are predicted based on sequences of prior actions within a given environment.

Generally, generating a response to a query using generative artificial intelligence models may be computationally expensive. For example, in a chatbot deployment in which a large language model is used to generate a response to a query formatted as a text query, a response to the query may be generated using a pass through the large language model for each token (e.g., word or part of word) generated as part of the response. The output of each pass may be a probability distribution on a set of tokens (word(s) or portions of words) from which the next token may be selected, either by sampling or based on maximum likelihood. Because a pass through a large language model is used to generate each word (or token(s)) in a response to a query, the computational expense may be modeled as the product of the number of words included in the response and the computational resource expense (e.g., in terms of processing power, memory bandwidth, or other compute resources used) of performing a pass through the large language model, which generally increases as the number of parameters within the large language model increases.

### BRIEF SUMMARY

Certain aspects of the present disclosure provide a method for generating a response to an input query using a generative artificial intelligence model. The method generally includes receiving an input for processing. A prompt representing the received input is generated based on the received input, contextual information associated with the received input, and a prompt-generating artificial intelligence model. The generated prompt is output to a generative artificial intelligence model for processing. A response to the generated prompt is received from the generative artificial intelligence model and output as a response to the received input.

Certain aspects of the present disclosure provide a method for generating a response to an input query using a generative artificial intelligence model. The method generally includes receiving an input prompt for processing. Based on user information associated with the received prompt, contextual information associated with the received prompt is requested from a personal knowledge repository and received. A query is generated based on the input prompt and the contextual information associated with the input prompt. The generated query is output to a generative artificial intelligence model for processing. A response to the generated query is received from the generative artificial intelligence model, and the response to the generated query is output as a response to the input prompt.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example hybrid computing environment in which queries are dispatched for processing on different devices within the hybrid computing environment, according to aspects of the present disclosure.

FIG. 2 illustrates an example hybrid computing environment in which a generative model on an edge device serves as a proxy for a generative model executing in a cloud environment, according to aspects of the present disclosure.

FIG. 3 illustrates an example hybrid computing environment in which queries are dynamically offloaded for processing from an edge device to another device in a hybrid environment, according to aspects of the present disclosure.

FIG. 4 illustrates an example hybrid computing environment in which queries are processed by generative artificial intelligence models based on speculative decoding, according to aspects of the present disclosure.

FIG. 5 illustrates example operations for processing a query by a generative artificial intelligence model on an edge device acting as a proxy for a generative artificial intelligence model executing in a cloud environment, according to aspects of the present disclosure.

FIG. 6 illustrates an example hybrid computing environment in which external resources are used to augment the processing of queries using generative artificial intelligence models on one or more devices within the hybrid computing environment, according to aspects of the present disclosure.

FIG. 7 illustrates an example architecture for orchestrating the processing of queries using generative artificial intelligence models in a hybrid computing environment, according to aspects of the present disclosure.

FIG. 8 illustrates example operations for generating a response to an input query using generative artificial intelligence models and external knowledge sources, according to aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for generating responses to input queries using generative artificial intelligence models in a hybrid computing environment. The term “generative artificial intelligence model” is used interchangeably with the term “generative model” throughout the present disclosure. The term “query” may also be used interchangeably with the term “prompt” throughout the present disclosure.

Generally, generative artificial intelligence models generate a response to a query input into the model. For example, a large language model deployed within a chatbot can generate a response to a query using multiple passes through the large language model, with each successive pass being based on the query and the tokens (or words) generated using previous passes through the large language model. Generally, these large language models may include a large number (e.g., billions or trillions) of weights or parameters within the model. Because of the size of these models and the operations performed on each token to predict what should be the next token generated in response to a query and the previously generated tokens, it may not be practical, or even possible, to deploy large language models on a variety of devices, such as (but not limited to) those that may have limited memory, storage, and/or processing capabilities relative to a cloud compute instance on which a large language model typically operates. Further, the memory bandwidth involved in generating a response to a query provided as input into a model may prevent compute resources from being used for other tasks.

To allow for generative artificial intelligence models to be used across different devices, differently sized generative artificial intelligence models can be trained and deployed to different devices according to the compute capabilities of these devices. For example, a compact model (e.g., trained with between 7 billion and 20 billion tokens) may be deployed to edge devices (or first set or type of devices), such as laptop computers, tablet computers, smartphones, or the like, while larger models (e.g., models trained with between 20 billion and 70 billion tokens, models trained with between 20 billion and 200 billion tokens, etc.) may be deployed to other devices (or second set or type of devices), such as server computers, a cloud compute instance, or other computing devices with more extensive compute capabilities. By using different-sized models, generative models can be used to generate responses to queries on a variety of devices. However, generally speaking, the size of a model may be related to the ability of the model to generate accurate responses to input queries. For example, more compact models may be able to generate accurate responses to a smaller range of queries than larger models, but as discussed, may be deployed on devices which may not be able to execute operations using these larger models due to a lack of available computing resources.

Aspects of the present disclosure provide techniques for orchestrating query processing by generative artificial intelligence models in a hybrid computing environment. In orchestrating or otherwise coordinating query processing across different devices in a hybrid computing environment including edge devices and cloud computing environments, queries can be executed on specific devices based on the properties of the query. In some aspects, information available at these devices can be used to augment responses generated by generative artificial intelligence models in the hybrid computing environment. Thus, queries can be routed for execution by the device(s) in the hybrid computing environment which can generate an accurate response while allowing computing resources on other devices to remain available for processing other queries using generative artificial intelligence models.

Aspects of the present disclosure provide techniques for processing queries using generative artificial intelligence models based on contextual information retrieved from one or more external knowledge repositories (such as knowledge graphs in which relationships between different items of data are modeled as a graph in which connections between different items represent a relationship between these different items). Generally, these external knowledge repositories may store a variety of data. The data may be, for instance, specific to a user of an edge device, specific to a group of related users (e.g., users in the same family, users in the same organization, etc.), or general across a variety of users. The contextual information may be used to generate a response to the input query that is grounded in the contextual information and thus is relevant to the specific user associated with the input query. By doing so, aspects of the present disclosure may improve the accuracy of responses generated using generative artificial intelligence systems. The improved accuracy of these responses may minimize, or at least reduce, the amount of resources consumed in re-generating responses to account for previously or otherwise unknown context and, in turn, allow computing resources to remain available for processing other queries using generative artificial intelligence models.

### Example Hybrid Computing Environments for Processing Queries Using Generative Artificial Intelligence Models

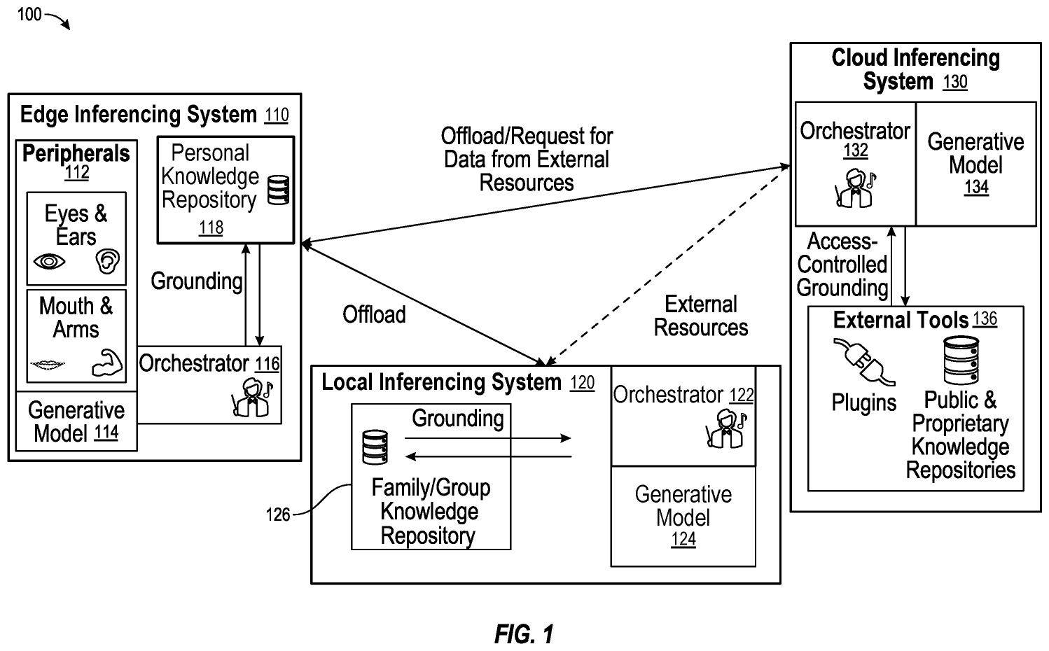

FIG. 1 illustrates an example hybrid computing environment 100 in which queries are dispatched for processing on different devices within the hybrid computing environment, according to aspects of the present disclosure.

As illustrated, hybrid computing environment 100 includes an edge inferencing system 110, a local inferencing system 120, and a cloud inferencing system 130. The edge inferencing system 110 may correspond to a personal computing device on which a generative artificial intelligence model, such as a large language model (LLM) trained to generate textual responses to a textual query, is deployed. The local inferencing system 120 may correspond to a computing system that exposes a generative artificial intelligence model to a defined group of users, such as members of a family, members of a computing network, or some other defined group of users. Finally, the cloud inferencing system 130 may correspond to a generally available computing system, hosted in a cloud computing environment or other computing environment, that exposes a generative artificial intelligence model to the general public. While FIG. 1 illustrates a hybrid computing environment including an edge inferencing system 110, a local inferencing system 120, and a cloud inferencing system 130, it should be recognized that the hybrid computing environment 100 may include any combination of any number thereof (e.g., may include an edge inferencing system 110 and a cloud inferencing system 130, an edge inferencing system 110 and a local inferencing system 120, a local inferencing system 120 and a cloud inferencing system 130, etc.).

Generally, the edge inferencing system 110 may correspond to one or more devices (or first set or type of devices) having the most restricted computing capabilities (e.g., processing speed, memory capacity, memory bandwidth, etc.) within the hybrid computing environment 100. The local inferencing system 120 may generally correspond to one or more devices (or third set or type of devices) having more extensive computing capabilities than the edge inferencing system 110. The cloud inferencing system 130 may generally correspond to one or more devices (or second set or type of devices) having more extensive computing capabilities than the local inferencing system 120.

The edge inferencing system 110 generally includes one or more peripheral devices 112, one or more generative models 114, an orchestrator 116, and a personal knowledge repository 118 (also referred to as a personal knowledge graph). The one or more peripheral devices 112 generally allow for the edge inferencing system 110 to ingest a query and contextual information related to the ingested query. The peripheral devices 112 included in or connected to (e.g., communicatively coupled with) the edge inferencing system 110 can include, for example, audio-visual capture devices that can capture audio-visual data, sensors that can capture movement data, and other devices that can provide contextual information related to usage of the edge inferencing system.

The orchestrator 116 generally identifies which system in the hybrid computing environment 100 is to process the ingested query (or parts thereof) and routes the ingested query to the identified system for processing. In some aspects, to identify the system that is to process the ingested query, the orchestrator 116 can, in some aspects, examine information about the topic of the query and estimate the complexity of the query (e.g., a complexity metric) based on the topic of the query. For topics with a complexity metric below a defined threshold or topics included in a defined set of topics that can be addressed using the generative model 114 at the edge inferencing system 110, the orchestrator 116 can dispatch the ingested query (and, in some aspects, the contextual information derived from the peripheral devices 112 and/or knowledge from the personal knowledge repository 118) to the generative model 114 for processing. In some aspects, the information based on which the generative model 114 generates a response to the ingested query may be further supplemented by data retrieved by the orchestrator 116 from one or more external resources (e.g., external tools 136 hosted at the cloud inferencing system 130) and/or one or more internal resources.

In some aspects, the orchestrator 116 can determine that the ingested query is of a sufficient level of complexity or implicates information that is hosted at either the local inferencing system 120 or the cloud inferencing system 130. In such a case, the orchestrator 116 can offload the ingested query to the local inferencing system 120 (e.g., for processing using a generative model 124 hosted at the local inferencing system 120) and/or the cloud inferencing system 130 (e.g., for processing using a generative model 134 hosted at the cloud inferencing system 130). Subsequently, the orchestrator 116 may receive a response from the system to which the ingested query is offloaded and output the received response to a user of the edge inferencing system 110 (e.g., by rendering the response on a display communicatively coupled with or integral to the edge inferencing system 110, transmitting one or more electronic messages including the response to a user of the edge inferencing system 110, outputting the received response as an audio output (e.g., as spoken output generated by a text-to-voice system) to a user of the edge inferencing system 120 etc.).

In some aspects, the orchestrator 116 can use contextual information related to the ingested query and/or information retrieved from the personal knowledge repository 118, to identify which device in the hybrid computing environment 100 to which the ingested query (or parts thereof) is to be dispatched for processing. For example, as discussed in further detail below, the peripheral devices 112 can capture data in various data modalities, such as visual data (e.g., image data, video data, etc.), audio data, gesture data, or the like, that provide context for the ingested query. In some aspects, this contextual data may be captured contemporaneously with the ingested query. In other aspects, this contextual data may include historical data captured prior to a time at which the ingested query was received. In cases in which the orchestrator 116 determines that an ingested query includes multimodal data which can be used to supplement the input query (or a textual representation of the input query, in cases where the input query is captured as audio data (e.g., speech or lyrics) and converted into a text string), the orchestrator 116 can dispatch the ingested query and the contextual information to the local inferencing system 120 and/or the cloud inferencing system 130 for processing, as these devices may have sufficient computing power or otherwise be better suited to generate a response to multimodal data.

In some aspects, the edge inferencing system 110 (e.g., the generative model 114, orchestrator 116, and/or other models (not illustrated in FIG. 1)) can transform an ingested query, contextual information related to the ingested query, and/or information retrieved from the personal knowledge repository 118 into a query that can be input into another generative artificial intelligence model (e.g., the generative model 124 at the local inferencing system 120 and/or the generative model 134 at the cloud inferencing system 130). As discussed in further detail below, the generated query may be a textual query that incorporates one or more of the ingested query and the contextual information associated with the ingested query, an embedding representation of the ingested query and the contextual information, a set of features derived from the ingested query and the contextual information, or the like. Based on various metrics, such as a complexity metric associated with the ingested query, whether the query implicates the use of data in a specific knowledge graph (or other knowledge repository), and the like, the orchestrator 116 can dispatch the generated query to the appropriate system in the hybrid computing environment 100 for processing.

The local inferencing system 120 generally includes an orchestrator 122 that receives requests to process input queries from the edge inferencing system 110, one or more generative models 124, and a private knowledge repository 126 that can be used (as discussed in further detail herein) to augment responses generated by the generative model 124. The private knowledge repository 126 may be, for example, a knowledge graph or other knowledge repository that contains information relevant to a user or a specific group of users. The information in the private knowledge repository 126 may be access controlled such that the knowledge contained therein is accessible to and usable by the user or members of the group (e.g., members of a family or a defined, restricted group of users). The generative model(s) 124 deployed on the local inferencing system 120 may be a larger model than the generative model 114 deployed on the edge inferencing system 110 and may thus be used to provide answers, for example, to more complex queries than those executed on the edge inferencing system 110. In some aspects, the orchestrator 122 at the local inferencing system 120 can interact with the external tools 136 (e.g., hosted in a cloud computing environment, such as a compute instance on which the cloud inferencing system is hosted) to augment responses generated by the generative artificial intelligence model 124.

The cloud inferencing system 130, as illustrated, includes an orchestrator 132 that receives requests to process input queries from at least the edge inferencing system 110, one or more generative models 134, and one or more external tools 136 (e.g., plugins, knowledge graphs (public and/or proprietary), etc.) that can be used (as discussed in further detail herein) to augment responses generated by the generative model(s) 134 on the cloud inferencing system 130 and/or responses generated by other generative artificial intelligence models (e.g., the generative model 114 hosted at the edge inferencing system 110 and/or the generative model 124 hosted at the local inferencing system 120) in the hybrid computing environment 100.

Generally, the generative model(s) 134 deployed on the cloud inferencing system 130 may be larger than the generative models 114 and 124 deployed on the edge inferencing system 110 and the local inferencing system 120, respectively. In some aspects, the generative model(s) 134 deployed on the cloud inferencing system 130 can be used to validate responses generated by the generative models 114 and 124 deployed on the edge inferencing system 110 and the local inferencing system 120, respectively. In further or alternative aspects, the generative model(s) 134 deployed on the cloud inferencing system 130 can be used to generate responses to queries offloaded from the edge inferencing system 110.

In some aspects, the one or more external tools 136 may allow for access-controlled grounding of responses generated by the generative model 134, in which data in these external tools 136 is restricted to specific users such that responses generated by the generative model 134 can be modified by or conditioned on user-specific information that may differ for different users of the cloud inferencing system 130.

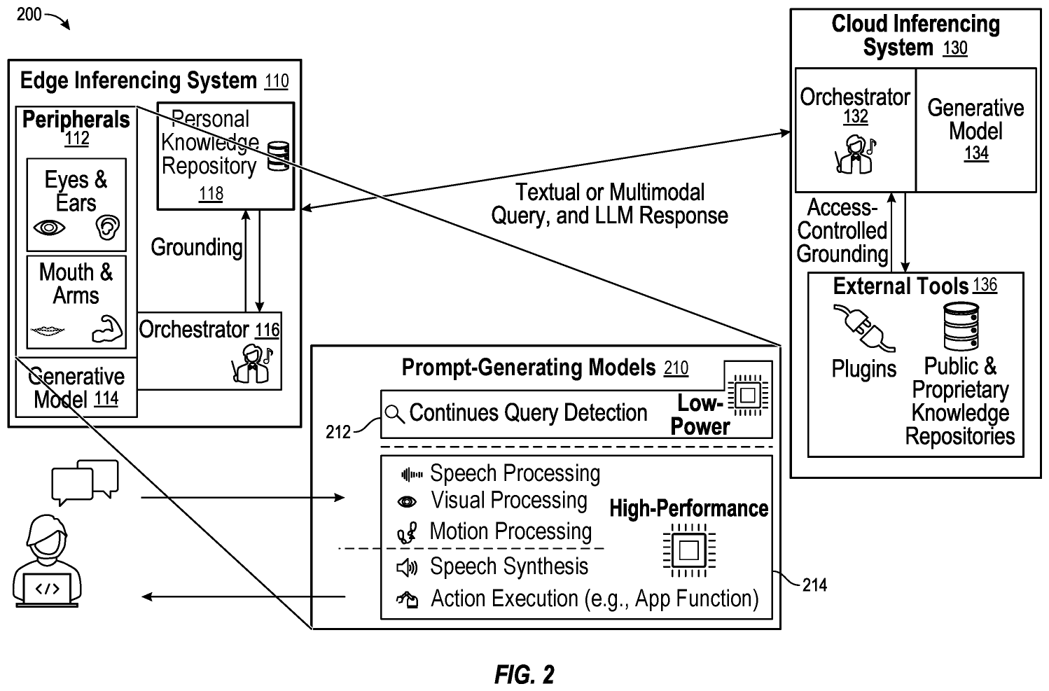

FIG. 2 illustrates an example hybrid computing environment 200 in which a generative model on an edge device serves as a proxy for a generative model executing in a cloud environment, according to aspects of the present disclosure.

As illustrated, the edge inferencing system 110 includes a plurality of prompt-generating models 210 associated with the peripheral devices 112. To allow for the prompt-generating models 210 (and/or the one or more generative models 114) to act as a proxy for the generative model 134 executing on the cloud inferencing system 130, the prompt-generating models 210 may act as one or more prompt-generating models to pre-process user inputs into the edge inferencing system 110 and generate a prompt for processing based on the received input and contextual information associated with the input.

As illustrated, the prompt-generating models 210 may include a first model 212 (e.g., a low-power model) and a second model 214 (e.g., a high-performance model). In other aspects, more the prompt-generating models 210 may have more than two models. In some aspects, each of the prompt-generating models 210 may have a different performance level, size, parameter count, etc. (e.g., a first model is a low-power model, a second model is a mid-power model, and a third model is a high-power model).

To initiate processing of a query, the edge inferencing system 110 receives an input through the one or more peripheral devices 112. In some aspects, the low-power model 212, which may execute continuously (e.g., as a background process, daemon, service, or the like) can ingest signals and other data generated by the peripheral devices 112 to determine when the ingested data is associated with a query. For example, the low-power model 212 may execute continuously to identify, from spoken utterances captured by a microphone or other audio capture device connected with or integral to the edge inferencing system 110, the presence of specific key words indicative of a user presenting a query for processing. These specific keywords may be identified contemporaneously with ingesting the query or prior to ingesting the query. It should be recognized that the foregoing is merely an example of a low-power model detecting that a user is inputting a query for processing, and other techniques by which the low-power model 212 can detect that ingested data is associated with a query may be contemplated.

When the low-power model 212 determines that a user has begun to input a query into the edge inferencing system 110, the low-power model 212 can activate the high-performance model 214 to generate textual data and feature outputs from data captured by the peripheral devices 112 that can be provided as an input into a generative artificial intelligence model (e.g., the generative model 114 deployed on the edge inferencing system 110, the generative model 134 deployed on the cloud inferencing system 130, and/or other generative models deployed on other devices within the hybrid computing environment 200 and not illustrated in FIG. 2). The high-performance model 214 may, for example, allow for the integration of multiple data modalities into a multimodal query output to a generative model for further processing. By doing so, text, audio, video, sensor, and other data modalities may be combined to allow for broader contextual information to be included in a query, which may allow the generative model to generate a response to a query that leverages the additional information captured by various peripheral devices as context for a textual representation of a query.

In some aspects, the low-power model 212 may be omitted, and the high-performance model 214 can be invoked on-demand in order to process inputs from the peripherals integrated with or connected to the edge inferencing system 110 and generate the data (e.g., textual data) and/or feature outputs that can be provided as an input into a generative artificial intelligence model.

The orchestrator 116 at the edge inferencing system 110 can use the data and/or feature outputs generated by the prompt-generating models 210 to generate a prompt and transmit the prompt to the cloud inferencing system (or the local inferencing system 120 (not shown in FIG. 2)) for processing. In response, the generative model 134 at the cloud inferencing system 130 generates a response based on the received prompt and transmits the generated response to the orchestrator 116 at the edge inferencing system 110. The orchestrator 116 can then output (e.g., textually, visually, audibly, etc.) the generated response to the user of the edge inferencing system 110.

In some aspects, the generative model 114 deployed on the edge inferencing system may be deactivated or otherwise not used in generating a response to an input query. The low-power model 212 and high-performance model 214 may be used as a proxy for the generative model 134 deployed on the cloud inferencing system. As discussed, in acting as a proxy for the generative model 134, the prompt-generating models 210 can perform various preprocessing tasks on inputs captured from the peripheral devices 112 at the edge inferencing system 110 prior to generating a query and transmitting the query to the cloud inferencing system 130 for processing to offload tasks from the generative model 134. By doing so, aspects of the present disclosure may improve the responsiveness, or at least the perceived responsiveness, of the generative model 134 to an input query received at the edge inferencing system 110 and dispatched to the cloud inferencing system 130 for processing.

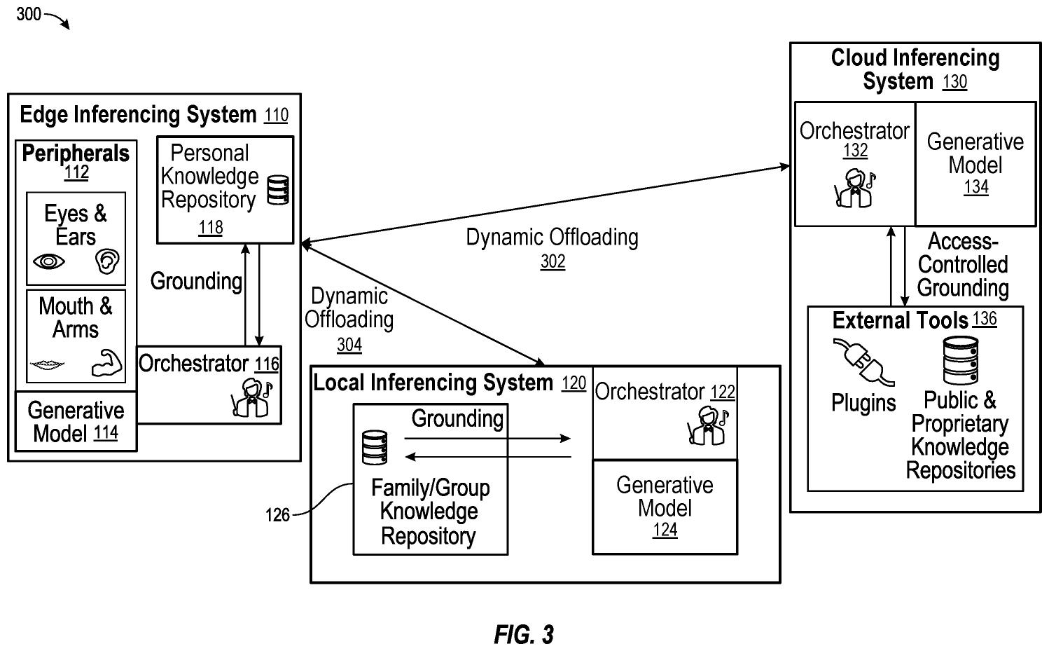

FIG. 3 illustrates an example hybrid computing environment 300 in which queries are dynamically offloaded for processing from an edge inferencing system (e.g., 110) to another system (e.g., 120 and/or 130) in the hybrid computing environment 300, according to aspects of the present disclosure.

In the hybrid computing environment 300, the edge inferencing system 110 can determine whether to generate a response to a received query using one or more of the generative models 114 deployed on the edge inferencing system 110 or whether to offload processing (e.g., via offloading messages 302 or 304 instructing the recipient system to generate a response to a received query) of the received query to another system (e.g., the local inferencing system 120 or the cloud inferencing system 130). The orchestrator 116 at the edge inferencing system 110 can determine which system is to be used to generate a response. The determination may be based, for example (but not limited to), on predefined assignments of specific tasks to specific systems in the hybrid computing environment 300, evaluation of a response generated by the generative model 114 deployed on the edge inferencing system 110, evaluation of the complexity of a task related to a received query, and/or the like.

Generally, decisions of whether to offload a query to the local inferencing system 120 or the cloud inferencing system 130 may be made in an attempt to preserve the accuracy of responses generated within the hybrid computing environment 300 for a wide range of queries. In other aspects, decisions of whether to offload a query to the local inferencing system 120 or the cloud inferencing system 130 may be made on one or more other criteria (e.g., utilization of resources on one or more of the systems, cost of processing on one or more of the systems, latency or amount of time by processing on one or more of the systems, etc.)

In some examples, the orchestrator 116 at the edge inferencing system 110 can initially route a received query to the generative model 114 deployed on the edge inferencing system 110 to generate an initial response. In some aspects, the orchestrator 116 can determine whether the initial response is correct or incorrect. For instance, the orchestrator 116 can use various tools, such as a local compiler, a local knowledge repository (e.g., the personal knowledge repository 118 at the edge inferencing system 110), or the like, to determine whether the initial response is correct or incorrect. For example, in a code generation example in which the query relates to generating source code (e.g., in Python, C++, or some other programming language) to perform a particular task, the orchestrator 116 can use a compiler/interpreter and a unit testing framework to check the generated source code. If the compiler/interpreter fails to execute the generated code successfully, or if one or more tests executed on the generated source code fail, the orchestrator 116 can determine that the query should be executed on a different device and can offload the query for processing on the local inferencing system 120 or the cloud inferencing system 130. In some aspects, the orchestrator 116 can predict whether the initial response is likely to be correct or incorrect (e.g., based on a confidence level or accuracy score associated with the initial response) and determine, based on the prediction, whether to offload the query for processing on the local inferencing system 120 or the cloud inferencing system 130. Thus, aspects of the present disclosure may allow for a response to be quickly output when the initial response is determined to be correct, and an accurate response can be generated by a system (e.g., the local inferencing system 120 or the cloud inferencing system 130) with more processing power when the initial response is determined to be incorrect.

When the orchestrator 116 at the edge inferencing system 110 determines that a received query should be offloaded from the edge inferencing system 110 for processing, the orchestrator can provide the query to one or both of the local inferencing system 120 or the cloud inferencing system 130 for processing. A determination of whether to offload a received query to the local inferencing system 120 or the cloud inferencing system 130 may be performed, for example, based on complexity metrics associated with the received query (which may, in some aspects, be related to metrics such as confidence scores or accuracy scores, with lower confidence or accuracy scores for an initial response corresponding to more complex queries which should be offloaded to another system for processing and higher confidence or accuracy scores for an initial response corresponding to less complex queries for which execution can remain at the edge inferencing system 110). The most complex queries (e.g., queries associated with a defined complexity level above a defined threshold) may be offloaded to the cloud inferencing system 130, while other, less complex queries may be offloaded to the local inferencing system 120 for processing.

In some aspects, the edge inferencing system 110 and one or both of the local inferencing system 120 or the cloud inferencing system 130 can generate responses to a received query received at the edge inferencing system 110. In such a case, a user of the edge inferencing system 110 can receive an initial answer from the edge inferencing system 110 and subsequently receive an answer (which, as discussed above, may be more accurate due to the increased size of the generative models 124 and 134 relative to the size of the generative model 114 on the edge inferencing system 110) from another system to which the received query is offloaded or routed for processing (e.g., serially receive responses from the edge inferencing system 110, the local inferencing system 120, and the cloud inferencing system 130). In some aspects, responses generated by the edge inferencing system 110 and one or both of the local inferencing system 120 or the cloud inferencing system 130 may be presented simultaneously so that the user of the edge inferencing system 110 can select a response that the user deems to be the most accurate response to the received query.

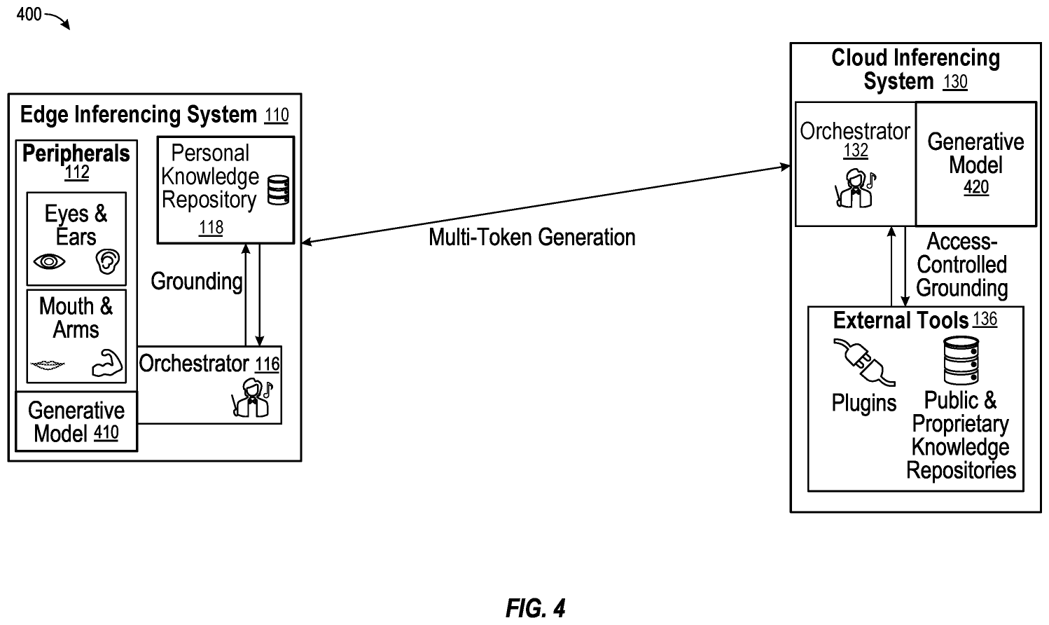

FIG. 4 illustrates an example hybrid computing environment 400 in which queries are processed by generative artificial intelligence models based on speculative decoding, according to aspects of the present disclosure. It should be understood that the aspects illustrated in FIG. 4 and described herein may be implemented with or within the hybrid computing environments 100, 200, and 300 described above.

In the hybrid computing environment 400, generative models 410 and 420 deployed on the edge inferencing system 110 and the cloud inferencing system 130, respectively, may operate in conjunction to generate a response to a received query. In some aspects, the generative model 410 deployed on the edge inferencing system 110 can generate a partial response, or multiple candidate partial responses, and provide the partial response to the generative model 420 deployed on the cloud inferencing system 130 for verification. The generative model 420 deployed on the cloud inferencing system 130 can identify a correct response from the generated partial response or candidate partial responses and provide the identified correct response back to the edge inferencing system 110 for use in generating further portions of the response to the query until the response is completed. The generative model 410 deployed on the edge inferencing system 110 may be referred to hereafter as a draft model, and the generative model 420 deployed on the cloud inferencing system 130 may be referred to hereafter as a target model.

In a speculative decoding pipeline, the draft model 410 may speculatively generate n tokens autoregressively, according to the expression:

$${x}_{t + 1}^{draft} \sim {p}_{t}^{draft} = {p}^{draft} ( x \vert {x}_{0} , … {x}_{t} ) , {x}_{t + 2}^{draft} \sim {p}_{t + 1}^{draft} , … , {x}_{t + n}^{draft} \sim {p}_{t + n - 1}^{draft}$$

where xₜ₊₁^{draft} corresponds to the t+1^{th} token generated from a probability distribution pₜ^{draft} for the t^{th} token based on conditional probabilities assuming the selection of tokens x₀ through xₜ.

The target model 420 takes the generated n tokens and processes the n tokens in parallel to generate probability distributions p for each of the n tokens, according to the expression:

$$[ {p}_{t}^{target} , {p}_{t + 1}^{target} , … , {p}_{t + n}^{target} ] = {[ {p}^{target} ( x \vert {x}_{0} , … {x}_{t} , {x}_{t + 1}^{draft} , … , {x}_{t + k}^{draft} ) ]}_{k = 1 , 2 , … , n}$$

The target model 420 can then verify the tokens generated by the draft model 410 by comparing distributions from the draft model 410 and target model 420 to determine whether a token is accepted or rejected. A given token xₜ₊ₖ^{draft} may be accepted when ƒ (pₖ^{draft}, pₖ^{target})<a, for a function ƒ and a threshold a, with the threshold a, selected such than an accepted token has a high probability of being a valid token for inclusion in a response to an input query. Otherwise, the token may be rejected. The final token may then be generated at the first rejection position or at the last position n as a function of pₖ^{draft} and pₖ^{target} (e.g., represented by a function g (pₖ^{draft}, pₖ^{target})).

In some aspects, the draft model 410 can speculatively generate tokens on a group basis. In doing so, groups of tokens may be selected in aggregate as candidate responses to an input query, with these candidate responses being represented as a tree data structure having the input query as the root node of the tree. The target model 420 can generate the output distribution for each partial path, using a single pass through the target model, by including all tree nodes in the generated tree as token inputs and performing masked self-attention and positional encodings for each partial path within the tree.

In some aspects, speculative decoding may be performed recursively. In such a case, the target model 420 recursively performs rejection sampling on the tokens generated by the draft model 410 and included in the generated tree and a probability distribution q provided as input to the target model 420. Rejection sampling may be performed recursively at each node in the generated tree. In recursively performing rejection sampling, the target model 420 can accept or reject a token and adjust the probability distribution used to verify a subsequent token in the generated tree. If a token is rejected, an updated probability distribution q′=(q−p) may be generated for use in evaluating subsequent tokens in the tree, where p represents the probability associated with the rejected token from the original probability distribution q. Subsequently, the updated probability distribution q′ may be used to evaluate the next token in the tree.

In some aspects, speculative decoding may be achieved using a single generative model that combines the functionality of the draft model and the target model discussed above. In doing so, draft token generation, target token generation, and verification may be parallelized in a single generative artificial intelligence model. Using a single generative model may, for example, reduce the computational expense involved in generating both the target model 420 and the draft model 410, increase the performance of generative tasks by executing token verification and speculative generation in one pass through the single generative model, reduce the amount of memory used in storing models used for speculative decoding in generative tasks, and so on.

In some aspects, the draft model 410 and the target model 420 can operate in parallel, or substantially in parallel, such that the draft model 410 (deployed on the edge inferencing system) speculatively generates tokens responsive to the query while the target model 420 (deployed on the cloud inferencing system) validates a set of tokens previously generated by the draft model 410. In doing so, to maximize, or at least increase, throughput (e.g., the number of tokens generated per second), the draft model 410 executing on the edge device may continually generate batches of candidate tokens (or sets of tokens) and output these tokens to the target model 420 executing on a server (e.g., in a cloud computing environment). When the target model 420 returns a set of accepted tokens, the draft model 410 prunes the sample tree to conform to the set of accepted tokens. In some aspects, when the set of accepted tokens is the null set (e.g., when the target model 420 accepts no tokens), the draft model 410 may backtrack to the last token accepted by the target model 420 and restart speculative token generation from the last token. For example, in order to backtrack, the draft model 410 can prune a generated tree of sample tokens to the last accepted token and restart speculative generation based on the pruned tree.

Examples of speculative generation and decoding in generative artificial intelligence models are described in further detail in U.S. Provisional Patent Application Ser. No. 63/454,605, filed Mar. 24, 2023, and in U.S. Provisional Patent Application Ser. No. 63/460,850, filed Apr. 20, 2023, the entire contents of both of which are incorporated by reference herein.

It should be understood that while FIG. 4 illustrates the use of an edge inferencing system 110 and a cloud inferencing system 130 to perform speculative decoding with the draft model 410 hosted on the edge inferencing system 110 and the target model 420 hosted on the cloud inferencing system 130, a single system may host both the draft model 410 and the target model 420. In such a case, the draft model 410 can provide a batch of draft tokens to the target model 420 directly for processing, as discussed above, without transmitting these tokens to a different computing system.

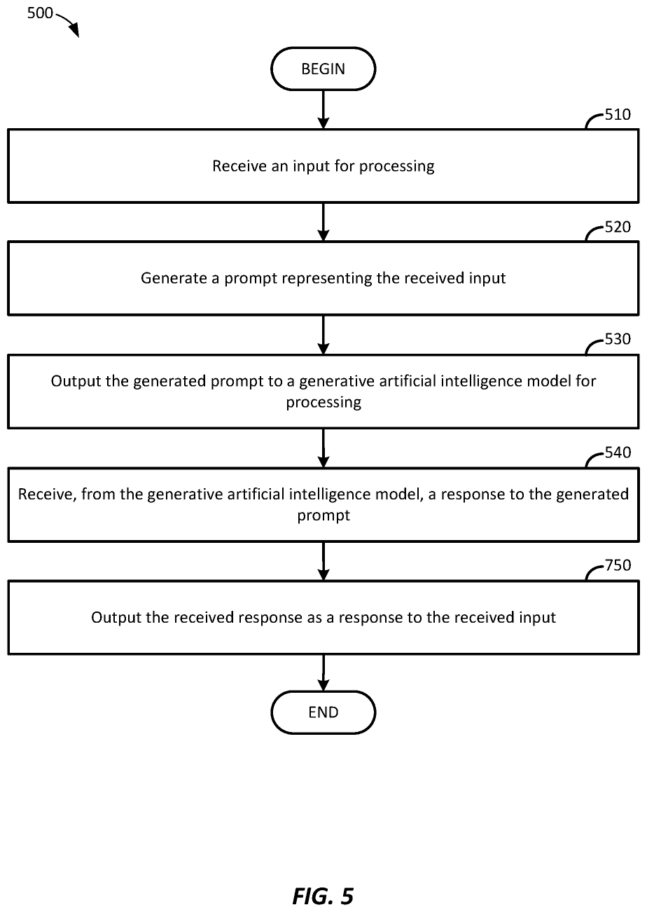

FIG. 5 illustrates example operations 500 for processing a query by a generative artificial intelligence model on an edge device acting as a proxy for a generative artificial intelligence model executing in a cloud environment, according to aspects of the present disclosure. In some aspects, the operations 500 may be performed, for example, by an edge inferencing system 110 with a prompt-generating artificial intelligence model (e.g., prompt-generating models 210 as illustrated in FIG. 2). In some aspects, the operations 500 may be performed or include any of the features of any one or more of hybrid computing environments 100-400.

As illustrated, the operations 500 begin at block 510, with receiving an input for processing.

At block 520, the operations 500 proceed with generating a prompt representing the received input. In some aspects, the prompt may be generated based on the received input, contextual information associated with the received input, and a prompt-generating artificial intelligence model.

In some aspects, the prompt-generating artificial intelligence model comprises a model that generates the prompt based on multi-modal contextual data associated with one or more sensor inputs captured in association with (e.g., while or prior to but providing context for) receiving the input for processing.

In some aspects, generating the prompt representing the received input comprises generating a textual output based on the multi-modal contextual data input into the prompt-generating artificial intelligence model.

In some aspects, generating the prompt comprises generating a set of multi-modal features based on the multi-modal contextual data input into the prompt-generating artificial intelligence model.

In some aspects, the multi-modal contextual data comprises one or more of audio data, image data, or motion data captured while receiving the input for processing. Audio data may be captured via one or more audio capture peripherals (e.g., microphones) communicatively coupled with or integral to the edge device. Image data may be captured via one or more imaging device peripherals (e.g., still and/or video cameras) communicatively coupled with or integral to the edge device. Motion data may be captured via one or more imaging device peripherals (e.g., still and/or video cameras), motion detecting sensors (e.g., photodiodes, Hall-effect sensors, etc.), or the like communicatively coupled with or integral to the edge device.

At block 530, the operations 500 proceed with outputting the generated prompt to a generative artificial intelligence model for processing. In some aspects, the generative artificial intelligence model may be a different model from the prompt-generating artificial intelligence model. In some aspects, the prompt-generating generative artificial intelligence model may be the same model as the generative artificial intelligence model.

In some aspects, outputting the generated prompt to the generative artificial intelligence model includes identifying a model from a plurality of generative models deployed in a distributed computing environment for processing the generated prompt. In some aspects, the identification of the model for processing the generated prompt may be based, at least in part, on a task identified in the generated prompt. The generated prompt may be output to the identified model from the plurality of generative models.

In some aspects, outputting the generated prompt to the generative artificial intelligence model includes generating an initial response based on a local generative artificial intelligence model. A quality of the initial response may be evaluated, and based on determining that the quality of the initial response does not meet a threshold quality metric, outputting the generated prompt to a remote generative artificial intelligence model for processing. In some aspects, outputting the generating prompt to the remote generative artificial intelligence model may include estimating a complexity of a task associated with the generated prompt. A model to which the generated prompt is to be output may be selected from a plurality of generative models based on the estimated complexity. The generated prompt may be output to the selected model from the plurality of generative models.

At block 540, the operations 500 proceed with receiving, from the generative artificial intelligence model, a response to the generated prompt.

At block 550, the operations 500 proceed with outputting the received response as a response to the received input.

In some aspects, receiving the input for processing includes detecting (e.g., via a query detection artificial intelligence model) input of a query from a user of a computing device. Based on detecting the input of the query from the user of the computing device, the prompt-generating artificial intelligence model may be activated. The prompt-generating artificial intelligence model may be subsequently deactivated based on outputting the received response as the response to the received input.

### Example Knowledge Resource-Based Grounding of Responses Generated by Generative Artificial Intelligence Models in a Hybrid Computing Environment

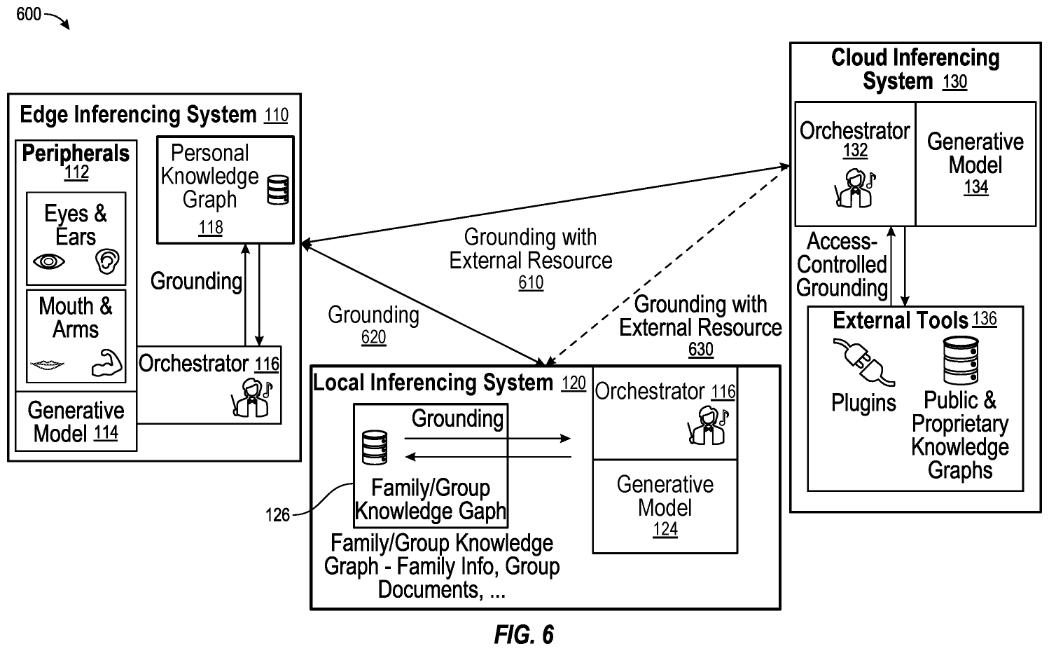

FIG. 6 illustrates an example hybrid computing environment 600 in which external resources are used to augment the processing of queries using generative artificial intelligence models on one or more devices within the hybrid computing environment 600, according to aspects of the present disclosure. The use of external knowledge resources to augment the processing of queries using generative artificial intelligence models may, in some aspects, be implemented with any of the various aspects discussed herein (e.g., in the hybrid computing environments 100, 200, 300, and 400 (amongst others, not illustrated) of FIGS. 1 through 4 discussed above).

In the hybrid computing environment 600, the orchestrator 116 at the edge inferencing system 110 can determine (i) whether to use external resources (e.g., the personal knowledge repository 118, the private knowledge repository 126 and/or the external tools 136, amongst others) to augment the processing of a received query and/or (ii) how to use these external resources. These external tools may include, for example, plugins deployed on the edge inferencing system 110, the local inferencing system 120, and/or the cloud inferencing system 130, knowledge repositories 118, 126 and external tools 136 (e.g., knowledge graphs) deployed on the edge inferencing system 110, the local inferencing system 120, and the cloud inferencing system 130, respectively, and/or the like.

In some aspects, the orchestrator 116 at the edge inferencing system 110 can augment a received query with information retrieved from an external resource prior to dispatching the augmented query to a generative artificial intelligence model (e.g., one or more of the generative model 114 at the edge inferencing system 110, the generative model 124 at the local inferencing system 120, and/or the generative model 134 at the cloud inferencing system 130) for processing. In another example, the orchestrator 116 at the edge inferencing system 110 can retrieve information from the local inferencing system 120 and/or cloud inferencing system 130 (e.g., via groundings 610 or 620 illustrated in FIG. 6) for use in augmenting the received query prior to dispatch to a generative artificial intelligence model for processing.

Orchestrators 122, 132 at the local inferencing system 120 or cloud inferencing system 130, respective, can use access controls and other information related to the identity of the user of the edge inferencing system to identify which external resources can be accessed in order to retrieve and provide relevant information to the edge inferencing system for use in augmenting a received query. Generally, these access controls may prevent users in one working group from accessing private knowledge repositories associated with a different working group.

In some aspects, the orchestrator 116 at the edge inferencing system 110 can use the external resources to perform various checks on responses generated by a generative artificial intelligence model within the hybrid computing environment 600. If the orchestrator 116 at the edge inferencing system 110 determines that a response generated by a generative artificial intelligence model in the hybrid computing environment 600 is incorrect or is inconsistent with information associated with a particular user of the edge inferencing system, the orchestrator 116 at the edge inferencing system 110 can determine that a different generative artificial intelligence model should be used to generate a response and/or can revise the response based on knowledge associated with that user (e.g., using the personal knowledge repository 118 stored on the edge inferencing system 110 and/or private knowledge repositories located at the local inferencing system 120 or the cloud inferencing system 130).

In some aspects, the external resources can be used to minimize, or at least reduce, memory utilization during operations using generative artificial intelligence models. For example, these external resources can be used to improve the quality of a response by maintaining a repository in which the current query and candidate responses can be stored (e.g., so that such candidate responses need not be regenerated), and a conversation history can be maintained so that answers to queries previously presented within the hybrid computing environment 600 can be provided as a response without invoking response generation operations using the generative artificial intelligence models.

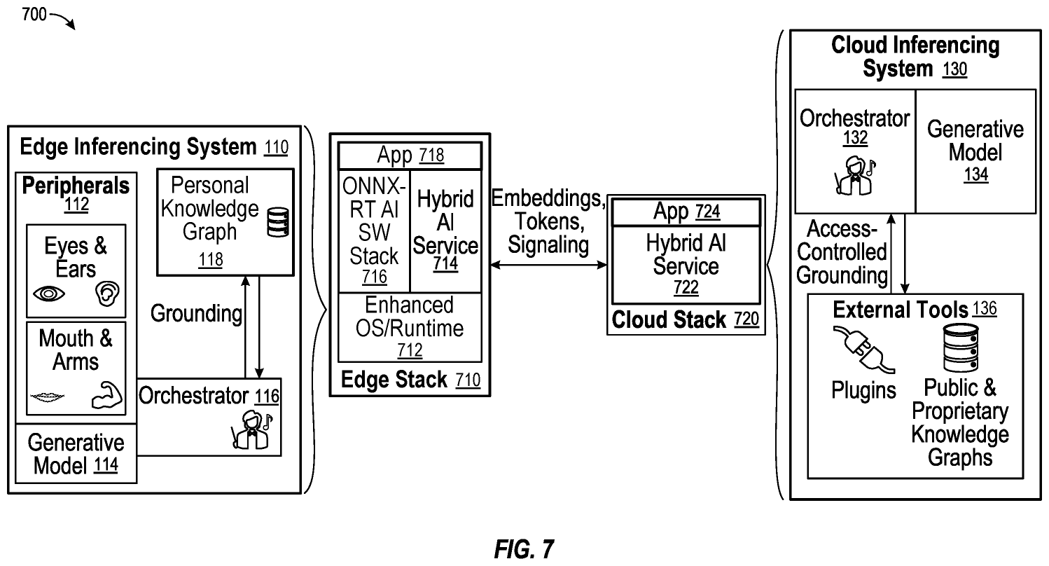

FIG. 7 illustrates an example hybrid computing environment architecture 700 for orchestrating the processing of queries using generative artificial intelligence models in a hybrid computing environment, according to aspects of the present disclosure. The orchestration of query processing illustrated in FIG. 7 may, in some aspects, be implemented with any of the various aspects discussed herein (e.g., in the hybrid computing environments 100, 200, 300, 400, and 600 (amongst others, not illustrated) of FIGS. 1 through 4 and 6 discussed above).

To allow for a variety of applications to operate in a hybrid computing environment, as discussed above, the hybrid computing environment architecture 700 may expose the orchestrators 116, 132 and generative models 114, 134 of the edge inferencing system 110 and the cloud inferencing system 130, respectively as a service (e.g., a background process, daemon, etc.) located on devices in the hybrid computing environment.

As illustrated, on an edge inferencing system 110 (e.g., a laptop computer, tablet computer, smartphone, and/or the like), the orchestrator 116 and generative model(s) 114 may be deployed in an edge stack 710 as a hybrid artificial intelligence service 714 located between the operating system 712 installed on the edge inferencing system 110 and an application 718 that uses the hybrid artificial intelligence service 714. The hybrid artificial intelligence service 714 may allow the orchestrator 116 to be model-agnostic and application-agnostic, which may in turn allow many different applications to leverage the performance benefits provided by offloading queries to other devices in a hybrid computing environment for processing. Similarly, as illustrated, various applications 718 can execute on top of the hybrid artificial intelligence service 714 located at the cloud inferencing system. In some aspects, the edge stack 710 may further include an artificial intelligence software stack 716 which may include one or more artificial intelligence models that generates a query, or at least a featurized version of inputs into the edge inferencing system 110, based on inputs captured by the peripheral devices 112 at the edge inferencing system 110.

The hybrid artificial intelligence service 714 included in the edge stack 710 associated with the edge inferencing system 110 and the hybrid artificial intelligence service 722 included in the cloud stack 720 associated with the cloud inferencing system 130 can manage orchestration, communication, and data security. Further, the hybrid artificial intelligence services 714, 722 can perform various data type conversions (e.g., integer-to-floating point, quantization, etc.) to provide data consistency across models used in the hybrid computing environment. Finally, because orchestration and communication are performed by a service, and not directly by the applications 718, 724 that use generative artificial intelligence models, a common interface can be used across different applications, which may minimize, or at least reduce, the risk of interface fragmentation across different applications.

### Example Operations for Generating Responses to Input Queries Using Generative Artificial Intelligence Models and Knowledge Resource Grounding

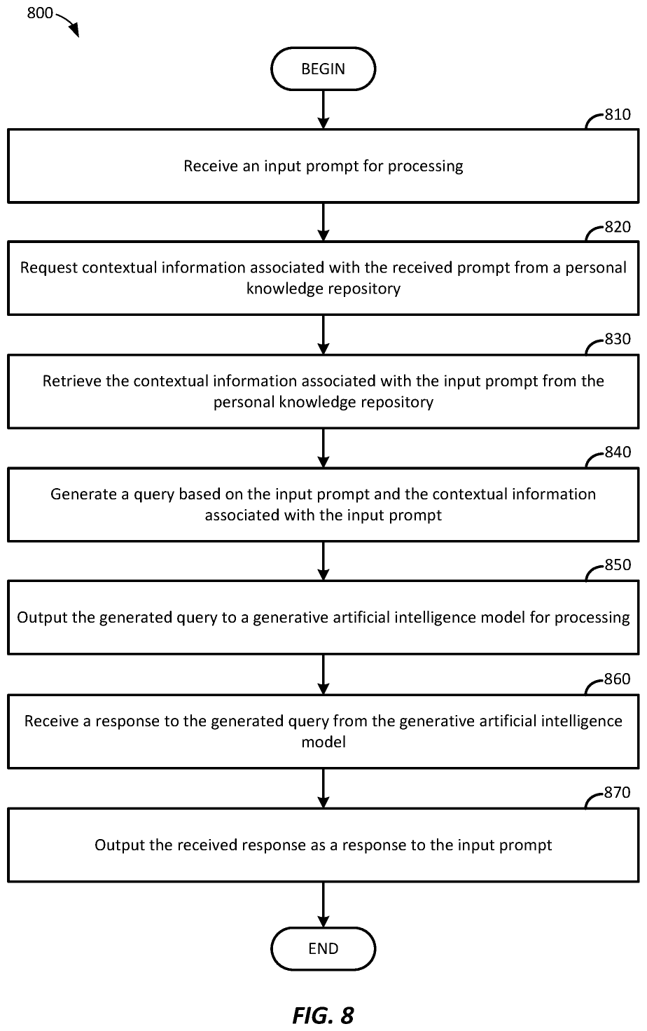

FIG. 8 illustrates example operations 800 for generating a response to an input query using generative artificial intelligence models and external knowledge sources, according to aspects of the present disclosure. It should be understood that the operations 800 may be performed in conjunction with the various aspects discussed above with respect to FIGS. 1 through 7.

As illustrated, the operations 800 begin at block 810, with receiving an input prompt for processing.

At block 820, the operations 800 proceed with requesting contextual information associated with the received prompt from a knowledge repository. Generally, the request may be based on user information associated with the received prompt. The user information may include, for example, information identifying a user account logged into a device or service through which the input prompt was received.

In some aspects, requesting the contextual information from the personal knowledge repository comprises identifying the knowledge repository from a universe of repositories for which a user associated with the user information has access permissions. For example, the user associated with the user information may have access to a personal data repository located at an edge device, a subset of personal data repositories located at a local server (e.g., the local inferencing system 120 illustrated in FIG. 7), and knowledge repositories located at a cloud inferencing system.

In some aspects, requesting the contextual information from the personal knowledge repository may include requesting the contextual information from a plurality of knowledge repositories. The contextual information may be received from one or more knowledge repositories of the plurality of knowledge repositories. Generally, the one or more knowledge repositories from which contextual information is received includes knowledge repositories which a user associated with the user information has permissions to access. Knowledge repositories which the user does not have permission to access may return, for example, a null data set or an error indicating that the user does not have permission to access these repositories.

In some aspects, the knowledge repository comprises a knowledge repository co-located with the generative artificial intelligence model. For example, the personal knowledge repository and the generative artificial intelligence model may be co-located on an edge device that received the input prompt.

In some aspects, the knowledge repository comprises a knowledge repository hosted on a local network and accessible by a group of users including a user associated with the user information.

In some aspects, the knowledge repository comprises a public knowledge repository located on a remote computing system.

At block 830, the operations 800 proceed with retrieving, from the knowledge repository, the contextual information associated with the received prompt.

At block 840, the operations 800 proceed with generating a query based on the input prompt and the contextual information associated with the input prompt.

At block 850, the operations 800 proceed with outputting the generated query to a generative artificial intelligence model for processing.

At block 860, the operations 800 proceed with receiving a response to the generated query from the generative artificial intelligence model.

At block 870, the operations 800 proceed with outputting the received response as a response to the input prompt.

In some aspects, the operations 800 further include retrieving information related to the query from an external resource. The received response may be updated based on the information retrieved from the external resource, and the revised response may be output as the response to the input prompt.

### Example Processing Systems for Processing Queries Using Generative Artificial Intelligence Models in a Hybrid Computing Environment

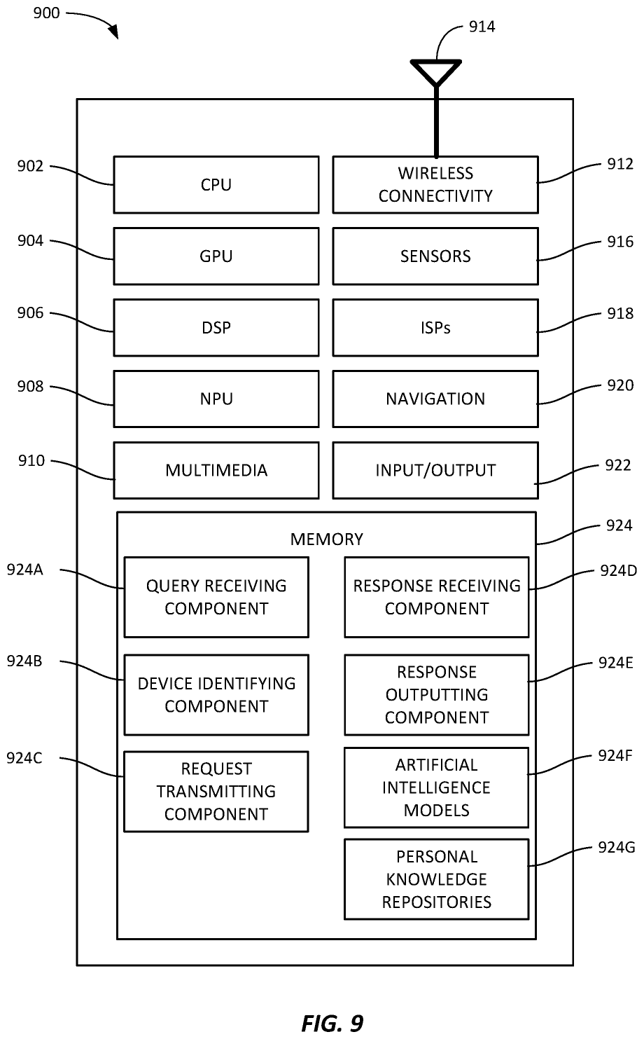

FIG. 9 depicts an example processing system 900 for generating a response to a query input into a generative artificial intelligence model in a hybrid environment (e.g., the hybrid computing environments 100, 200, 300, 400, and 600, amongst others), such as described herein for example with respect to FIGS. 5 and 8.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., of a memory 924).

The processing system 900 also includes additional processing components tailored to specific functions, such as a graphics processing unit (GPU) 904, a digital signal processor (DSP) 906, a neural processing unit (NPU) 908, and a connectivity component 912.

An NPU, such as the NPU 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 908 is a part of one or more of the CPU 902, the GPU 904, and/or the DSP 906. These may be located on a user equipment (UE) in a wireless communication system or another computing device.

In some examples, the connectivity component 912 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 912 may be further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

The processing system 900 may also include one or more input and/or output devices 922, such as screens, touch-sensitive surfaces (including touch-sensitive displays), physical buttons, speakers, microphones, and the like

In some examples, one or more of the processors of the processing system 900 may be based on an ARM or RISC-V instruction set.

The processing system 900 also includes a memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes a query receiving component 924A, a device identifying component 924B, a request transmitting component 924C, a response receiving component 924D, a response outputting component 924E, generative models 924F, and personal knowledge repositories 924G. The depicted components, and others not depicted, may be configured to perform various aspects of the methods described herein.

Generally, the processing system 900 and/or components thereof may be configured to perform the methods described herein.

### Example Clauses

Implementation details of various aspects of the present disclosure are described in the following numbered clauses:

Clause 1: A processor-implemented method, comprising: receiving an input for processing; generating a prompt representing the received input based on the received input, contextual information associated with the received input, and a prompt-generating artificial intelligence model; outputting the generated prompt to a generative artificial intelligence model for processing; receiving, from the generative artificial intelligence model, a response to the generated prompt; and outputting the received response as a response to the received input.

Clause 2: The method of Clause 1, wherein: receiving the input for processing comprises detecting input of a query from a user of a computing device; and the method further comprises activating the prompt-generating artificial intelligence model based on detecting the input of the query.

Clause 3: The method of Clause 2, further comprising deactivating the prompt-generating artificial intelligence model based on outputting the received response as the response to the received input.

Clause 4: The method of any of Clauses 1 through 3, wherein the prompt-generating artificial intelligence model comprises a model that generates the prompt based on multi-modal contextual data associated with one or more sensor inputs captured in association with receiving the input for processing.

Clause 5: The method of Clause 4, wherein generating the prompt representing the received input comprises generating a textual output based on the multi-modal contextual data input into the prompt-generating artificial intelligence model.

Clause 6: The method of Clause 4 or 5, wherein generating the prompt comprises generating a set of multi-modal features based on the multi-modal contextual data input into the prompt-generating artificial intelligence model.

Clause 7: The method of any of Clauses 4 through 6, wherein the multi-modal contextual data comprises one or more of audio data, image data, or motion data captured while receiving the input for processing.

Clause 8: The method of any of Clauses 1 through 7, wherein outputting the generated prompt to the generative artificial intelligence model comprises: identifying a model from a plurality of generative models deployed in a distributed computing environment for processing the generated prompt; and outputting the generated prompt to the identified model from the plurality of generative models.

Clause 9: The method of any of Clauses 1 through 8, wherein outputting the generated prompt to the generative artificial intelligence model comprises: generating an initial response based on a first generative artificial intelligence model; evaluating a quality of the initial response; and based on determining that the quality of the initial response does not meet a threshold quality metric, outputting the generated prompt to a second generative artificial intelligence model for processing, wherein the second generative artificial intelligence model is remote from the first generative artificial intelligence model.

Clause 10: The method of Clause 9, wherein the first generative artificial intelligence model comprises a model deployed on a same device as a device on which the input is received.

Clause 11: The method of Clause 9 or 10, wherein the second generative artificial intelligence model comprises a model deployed on a device remote from a device on which the first generative artificial intelligence model is deployed.

Clause 12: The method of any of Clauses 9 through 11, wherein outputting the generated prompt to the remote generative artificial intelligence model comprises: estimating a complexity of a task associated with the generated prompt; selecting a model from a plurality of generative models to which the generated prompt is to be output based on the estimated complexity; and outputting the generated prompt to the selected model from the plurality of generative models.

Clause 13: A processor-implemented method, comprising: receiving an input prompt for processing; requesting, based on user information associated with the received prompt, contextual information associated with the received prompt from a knowledge repository; retrieving, from the knowledge repository, the contextual information associated with the input prompt; generating a query based on the input prompt and the contextual information associated with the input prompt; outputting the generated query to a generative artificial intelligence model for processing; receiving, from the generative artificial intelligence model, a response to the generated query; and outputting the received response as a response to the input prompt.

Clause 14: The method of Clause 13, wherein requesting the contextual information from the knowledge repository comprises identifying the knowledge repository from a universe of repositories for which a user associated with the user information has access permissions.

Clause 15: The method of Clause 13 or 14, wherein: requesting the contextual information from the knowledge repository comprises requesting the contextual information from a plurality of knowledge repositories; and retrieving the contextual information comprises receiving the contextual information from one or more knowledge repositories of the plurality of knowledge repositories, the one or more knowledge repositories comprising knowledge repositories which a user associated with the user information has permissions to access.

Clause 16: The method of any of Clauses 13 through 15, wherein the knowledge repository comprises a knowledge repository co-located with the generative artificial intelligence model.

Clause 17: The method of Clause 16, wherein the knowledge repository and the generative artificial intelligence model are co-located on an edge device that received the input prompt.

Clause 18: The method of Clause 17, further comprising: retrieving information related to the query from an external resource; and updating the received response based on the information retrieved from the external resource.

Clause 19: The method of any of Clauses 13 through 18, wherein the personal knowledge repository comprises a knowledge repository hosted on a local network and accessible by a group of users including a user associated with the user information.

Clause 20: The method of any of Clauses 13 through 19, wherein the personal knowledge repository comprises a public knowledge repository located on a remote computing system.

Clause 21: A processing system, comprising: at least one memory having executable instructions stored thereon; and one or more processors configured to execute the executable instructions in order to cause the processing system to perform the operations of any of Clauses 1 through 20.

Clause 22: A processing system, comprising means for performing the operations of any of Clauses 1 through 20.

Clause 23: A non-transitory computer-readable medium having instructions stored thereon which, when executed by one or more processors, perform the operations of any of Clauses 1 through 20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions in order to cause the processing system to:
receive an input prompt for processing;
request, based on user information associated with the received prompt, contextual information associated with the received prompt from a knowledge repository;
retrieve, from the knowledge repository, the contextual information associated with the input prompt;
generate a query based on the input prompt and the contextual information associated with the input prompt;
output the generated query to a generative artificial intelligence model for processing;
receive, from the generative artificial intelligence model, a response to the generated query; and
output the received response as a response to the input prompt.

2. The processing system of claim 1, wherein to request the contextual information from the knowledge repository, the one or more processors are configured to cause the processing system to identify the knowledge repository from a group of repositories for which a user associated with the user information has access permissions.

3. The processing system of claim 1, wherein:
to request the contextual information from the knowledge repository, the one or more processors are configured to cause the processing system to request the contextual information from a plurality of knowledge repositories; and
to retrieve the contextual information, the one or more processors are configured to cause the processing system to receive the contextual information from one or more knowledge repositories of the plurality of knowledge repositories, the one or more knowledge repositories comprising knowledge repositories which a user associated with the user information has permissions to access.

4. The processing system of claim 1, wherein the knowledge repository comprises a knowledge repository co-located with the generative artificial intelligence model.

5. The processing system of claim 4, wherein the knowledge repository and the generative artificial intelligence model are co-located on an edge device that received the input prompt.

6. The processing system of claim 5, wherein the one or more processors are further configured to cause the processing system to:
retrieve information related to the query from an external resource; and
update the received response based on the information retrieved from the external resource.

7. The processing system of claim 1, wherein the knowledge repository comprises a knowledge repository hosted on a local network and accessible by a group of users including a user associated with the user information.

8. The processing system of claim 1, wherein the knowledge repository comprises a public knowledge repository located on a remote computing system.

9. A processor-implemented method, comprising:
receiving an input prompt for processing;
requesting, based on user information associated with the received prompt, contextual information associated with the received prompt from a knowledge repository;
retrieving, from the knowledge repository, the contextual information associated with the input prompt;
generating a query based on the input prompt and the contextual information associated with the input prompt;
outputting the generated query to a generative artificial intelligence model for processing;
receiving, from the generative artificial intelligence model, a response to the generated query; and
outputting the received response as a response to the input prompt.

10. The method of claim 9, wherein requesting the contextual information from the personal knowledge repository comprises identifying the knowledge repository from a group of repositories for which a user associated with the user information has access permissions.

11. The method of claim 9, wherein:
requesting the contextual information from the knowledge repository comprises requesting the contextual information from a plurality of knowledge repositories; and
retrieving the contextual information comprises receiving the contextual information from one or more knowledge repositories of the plurality of knowledge repositories, the one or more knowledge repositories comprising knowledge repositories which a user associated with the user information has permissions to access.

12. The method of claim 9, wherein the knowledge repository comprises a knowledge repository co-located with the generative artificial intelligence model.

13. The method of claim 12, wherein the knowledge repository and the generative artificial intelligence model are co-located on an edge device that received the input prompt.

14. The method of claim 13, further comprising:
retrieving information related to the query from an external resource; and
updating the received response based on the information retrieved from the external resource.

15. The method of claim 9, wherein the knowledge repository comprises a knowledge repository hosted on a local network and accessible by a group of users including a user associated with the user information.

16. The method of claim 9, wherein the knowledge repository comprises a public knowledge repository located on a remote computing system.

17. A processing system, comprising:
means for receiving an input prompt for processing;
means for requesting, based on user information associated with the received prompt, contextual information associated with the received prompt from a knowledge repository;
means for retrieving, from the knowledge repository, the contextual information associated with the input prompt;
means for generating a query based on the input prompt and the contextual information associated with the input prompt;
means for outputting the generated query to a generative artificial intelligence model for processing;
means for receiving, from the generative artificial intelligence model, a response to the generated query; and
means for outputting the received response as a response to the input prompt.

18. The processing system of claim 17, wherein the means for requesting the contextual information from the knowledge repository comprises means for identifying the knowledge repository from a group of repositories for which a user associated with the user information has access permissions.

19. The processing system of claim 17, wherein:
the means for requesting the contextual information from the knowledge repository comprises means for requesting the contextual information from a plurality of knowledge repositories; and
the means for retrieving the contextual information comprises means for receiving the contextual information from one or more knowledge repositories of the plurality of knowledge repositories, the one or more knowledge repositories comprising knowledge repositories which a user associated with the user information has permissions to access.

20. The processing system of claim 17, wherein the knowledge repository comprises a knowledge repository co-located with the generative artificial intelligence model.

21. The processing system of claim 20, wherein the knowledge repository and the generative artificial intelligence model are co-located on an edge device that received the input prompt.

22. The processing system of claim 21, further comprising:
means for retrieving information related to the query from an external resource; and
means for updating the received response based on the information retrieved from the external resource.

23. The processing system of claim 17, wherein the knowledge repository comprises a knowledge repository hosted on a local network and accessible by a group of users including a user associated with the user information.

24. The processing system of claim 17, wherein the knowledge repository comprises a public knowledge repository located on a remote computing system.

25. A non-transitory computer-readable medium having executable instructions stored thereon which, when executed by one or more processors, performs an operation comprising:
receiving an input prompt for processing;
requesting, based on user information associated with the received prompt, contextual information associated with the received prompt from a knowledge repository;
retrieving, from the knowledge repository, the contextual information associated with the input prompt;
generating a query based on the input prompt and the contextual information associated with the input prompt;
outputting the generated query to a generative artificial intelligence model for processing;
receiving, from the generative artificial intelligence model, a response to the generated query; and
outputting the received response as a response to the input prompt.

26. The computer-readable medium of claim 25, wherein requesting the contextual information from the knowledge repository comprises identifying the knowledge repository from a group of repositories for which a user associated with the user information has access permissions.

27. The computer-readable medium of claim 25, wherein:
requesting the contextual information from the knowledge repository comprises requesting the contextual information from a plurality of knowledge repositories; and
retrieving the contextual information comprises receiving the contextual information from one or more knowledge repositories of the plurality of knowledge repositories, the one or more knowledge repositories comprising knowledge repositories which a user associated with the user information has permissions to access.

28. The computer-readable medium of claim 25, wherein the knowledge repository comprises a knowledge repository co-located with the generative artificial intelligence model.

29. The computer-readable medium of claim 25, wherein:
the knowledge repository and the generative artificial intelligence model are co-located on an edge device that received the input prompt, and
the operations further comprise:
retrieving information related to the query from an external resource; and
updating the received response based on the information retrieved from the external resource.

30. The computer-readable medium of claim 25, wherein the knowledge repository comprises one or more of:
a knowledge repository hosted on a local network and accessible by a group of users including a user associated with the user information, or
a public knowledge repository located on a remote computing system.
